(19) United States
(12) Patent Application Publication
(10) Pub. No.: US 2008/0090108 A1
(43) Pub. Date: Apr. 17, 2008

(54) SEPARATOR FOR POLYMER ELECTROLYTE TYPE FUEL CELLS AND ITS FABRICATION PROCESS

(75) Inventors: Yasuhiro Uchida, Tokyo (JP); Hiroshi Yagi, Tokyo (JP); Tooru Serizawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: DAI NIPPON PRINTING CO., LTD., Shinjuku-ku (JP)

(21) Appl. No.: 11/695,196

(22) Filed: Apr. 2, 2007

(30) Foreign Application Priority Data
Apr. 3, 2006 (JP) 2006-101904

(51) Int. Cl. H01M 2/14; C25D 3/02

(52) U.S. Cl. 429/12; 156/150; 205/170; 205/317; 977/742; 977/734

(57) ABSTRACT

The object of the invention is to provide a separator of high strength plus high corrosion resistance which makes it possible to easily fabricate a polymer electrolyte type fuel cell having an extremely limited contact resistance with unit cells of an increased effective area, and a process for the fabrication of such separators. The invention provides a polymer electrolyte type fuel cell that comprises a metal substrate having a groove formed in at least one surface, an electrically conductive resin layer formed by electrodeposition in such a way as to cover the metal substrate, and a gas diffusion layer located on the surface of said metal substrate having a groove. Such a separator is fabricated by forming a groove in at least one surface of a metal sheet material to make a metal substrate; forming an electrically conductive coating film in such a way as to cover the metal substrate, using an electrically conductive electrodeposition solution; and engaging and placing a gas diffusion layer on the resin coating film except the groove in such a way as to veil the groove in the metal substrate, and thereafter curing the resin coating film to form a resin layer while joining the gas diffusion layer to the metal substrate to form a feed groove surrounded with the groove and the gas diffusion layer.

### BACKGROUND OF THE INVENTION

The present invention relates generally to a separator for fuel cells, and more particularly to a separator used between unit cells in a fuel cell built up of a plurality of unit cells stacked one upon another, each with electrodes located on both sides of a solid polymer electrolyte membrane, and a fabrication process of the same.

Briefly, a fuel cell is a device wherein fuel (a reducing agent) and oxygen or air (an oxidizing agent) are continuously supplied to it from outside for electro-chemical reactions through which electric energy is taken out, and classified depending on its working temperature, the type of the fuel used, its applications, etc. Recently developed fuel cells are generally broken down into five types depending primarily on the type of the electrolyte used: a solid oxide type fuel cell, a melt carbonate type fuel cell, a phosphoric acid type fuel cell, a polymer electrolyte type fuel cell, and an alkaline aqueous solution type fuel cell.

These fuel cells use hydrogen gas resulting from methane or the like as fuel. More recently, a direct methanol type fuel cell (sometimes abbreviated as DMFC) relying on direct use as fuel of a methanol aqueous solution has been known in the art, too.

Among others, attention has now been directed to a solid polymer type fuel cell (hereinafter also abbreviated as PEFC) having a structure wherein a solid polymer membrane is held between two electrodes and these components are further sandwiched between separators.

In general, this PEFC has a stacking structure wherein a plurality of unit cells, each having an air electrode (oxygen electrode) and a fuel electrode (hydrogen electrode) on both sides of a solid polymer electrolyte membrane, are stacked one upon another in such a way as to increase its electromotive force depending on what it is used for. A separator interposed between the unit cells is generally provided on its one side with a fuel gas feed groove for feeding fuel to one of the adjoining unit cells, and on another side with an oxidizing agent gas feed groove for feeding an oxidizing agent gas to another of the adjoining unit cells (JP(A)7-249417).

In the PEFC of such stacking structure, however, between the separator on the fuel gas feed side and the separator on the oxidizing agent gas feed side, there is a unit cell provided, wherein a gas diffusion layer, a catalyst layer, a polymer electrolyte membrane, a catalyst layer and a gas diffusion layer are stacked one upon another as an integral piece; there is the need of layer alignment, which renders worse the assembly work efficiency of unit cells at the time of fabrication. When there are poor layer contacts, there is a problem resulting in increased contact resistance.

One possible approach to getting around this problem is to tighten up separators forming a part of the PEFC of the stacking structure by means of bolts, thereby making sure layer contacts. However, this would lead to another problem from the provision of the necessary margin for bolting, which may otherwise give rise to decreases in the effective areas of unit cells.

### DISCLOSURE OF THE INVENTION

One object of the invention is to provide a separator of high strength and high correction resistance, which makes it possible to easily fabricate a polymer electrolyte type fuel cell having much reduced contact resistance with unit cells having larger effective areas. Another object is to provide a fabrication process for such a separator.

To accomplish such objects, the invention provides a separator for a polymer electrolyte type fuel cell, which comprises a metal substrate having a groove formed in at least one surface, an electrically conductive resin layer formed by electrodeposition in such a way as to cover said metal substrate, and a gas diffusion layer located on the surface of said metal substrate having a groove in such a way as to veil the groove.

In an embodiment of the invention, said resin layer contains an electrically conductive material.

In another embodiment of the invention, said electrically conductive material is at least one of a carbon particle, a carbon nanotube, a carbon nanofiber, a carbon nanohorn, and a corrosion-resistant metal.

The invention also provides a separator for a polymer electrolyte type fuel cell, characterized by comprising a metal substrate having a groove formed in at least one surface, an electrically conductive resin layer formed by electrolytic polymerization in such a way as to cover said metal substrate, and a gas diffusion layer located on the surface of said metal substrate having a groove in such a way as to veil the groove, wherein said resin layer includes a resin comprising an electrically conductive polymer and containing a conductivity-improving dopant.

Further, the invention provides a separator for a polymer electrolyte type fuel cell, which comprises a metal substrate having a groove formed in at least one surface, an electrically conductive resin layer formed by electrolytic polymerization in such a way as to cover said metal substrate, and a gas diffusion layer located on the surface of said metal substrate having a groove in such a way as to veil the groove, wherein said resin layer comprises a first resin layer comprising a resin of electrically conductive polymer formed by electrolytic polymerization and containing an electrical conductivity-improving dopant and a second resin layer formed by electrodeposition in such a way as to coat the first resin layer and containing an electrically conductive material.

In embodiment of the invention, said electrically conductive material is at least one of a carbon particle, a carbon nanotube, a carbon nanofiber, a carbon nanohorn, and a corrosion-resistant metal.

In another embodiment of the invention, said resin layer has a thickness ranging from 1 to 100 μm.

Further, the invention provides a process for fabrication of a separator for a polymer electrolyte type fuel cell built up of a plurality of unit cells stacked one upon another, each with electrodes located on both sides of a solid polymer electrolyte membrane, which comprises the steps of:

forming a groove in at least one surface of a metal sheet material to make a metal substrate,

forming an electrically conductive resin coating film in such a way as to cover said metal substrate, using an electrodeposition solution, and

engaging and placing a gas diffusion layer on said resin coating film except said groove in such a way as to veil said groove in said metal substrate, and thereafter curing said resin coating film to form an electrically conductive resin layer while joining said gas diffusion layer to said metal substrate to form a feed groove surrounded with said groove and said gas diffusion layer.

Still further, the invention provides a process for fabrication of a separator for a polymer electrolyte type fuel cell built up of a plurality of unit cells stacked one upon another, each with electrodes located on both sides of a solid polymer electrolyte membrane, which comprises the steps of:

forming a groove in at least one surface of a metal sheet material to make a metal substrate,

forming a resin coating film in such a way as to coat said metal substrate using an electrodeposition solution, and thereafter curing said resin coating film to form an electrically conductive resin layer, and

joining a gas diffusion layer to a site of said resin layer except said groove via an electrically conductive adhesive in such as a way as to veil said groove in said metal substrate, thereby forming a feed groove surrounded with said groove and said gas diffusion layer.

Yet further, the invention provides a process for fabrication of a separator for a polymer electrolyte type fuel cell built up of a plurality of unit cells stacked one upon another, each with electrodes located on both sides of a solid polymer electrolyte membrane, which comprises the steps of:

forming a groove in at least one surface of a metal sheet material to make a metal substrate,

using electrolytic polymerization to form a resin layer including a resin comprising an electrically conductive polymer and containing an electrical conductivity-improving dopant in such a way as to cover said metal substrate, and

joining a gas diffusion layer to a site of said resin layer except said groove via an electrically conductive adhesive in such as a way as to veil said groove in said metal substrate, thereby forming a feed groove surrounded with said groove and said gas diffusion layer.

Furthermore, the invention provides a process for fabrication of a separator for a polymer electrolyte type fuel cell built up of a plurality of unit cells stacked one upon another, each with electrodes located on both sides of a solid polymer electrolyte membrane, which comprises the steps of:

forming a groove in at least one surface of a metal sheet material to make a metal substrate,

using electrolytic polymerization to form a first resin layer including a resin comprising an electrically conductive polymer and containing an electrical conductivity-improving dopant in such a way as to cover said metal substrate and then using an electrodeposition solution to form an electrically conductive resin coating film in such a way as to cover said first resin layer, and

engaging and placing a gas diffusion layer on said resin coating film except said groove in such a way as to veil said groove in said metal substrate, and thereafter curing said resin coating film to form an electrically conductive resin layer while joining said gas diffusion layer to said metal substrate to form a feed groove surrounded with said groove and said gas diffusion layer.

Still furthermore, the invention provides a process for fabrication of a separator for a polymer electrolyte type fuel cell built up of a plurality of unit cells stacked one upon another, each with electrodes located on both sides of a solid polymer electrolyte membrane, which comprises the steps of:

forming a groove in at least one surface of a metal sheet material to make a metal substrate,

using electrolytic polymerization to form a resin layer including a resin comprising an electrically conductive polymer and containing an electrical conductivity-improving dopant in such a way as to cover said metal substrate, then using an electrodeposition solution to form a resin coating film in such a way as to cover said first resin layer, and thereafter curing said resin coating film to form a second, electrically conductive resin layer, and

joining a gas diffusion layer to a site of said second resin layer except said groove via an electrically conductive adhesive in such as a way as to veil said groove in said metal substrate, thereby forming a feed groove surrounded with said groove and said gas diffusion layer.

Such an inventive separator, because of comprising the gas diffusion layer as an integral piece, makes the alignment upon assembly work of unit cells for a polymer electrolyte type fuel cell much easier than could be possible with the prior arts and makes a lot more improvements in the contact of the layers forming the unit cell. It is thus possible to fabricate a polymer electrolyte type fuel cell comprising unit cells each having a larger effective area and an extremely limited contact resistance. Further, because the electrically conductive resin layer is formed by electrodeposition on the metal substrate, it is possible to make sure high corrosion resistance and high strength.

### BRIEF EXPLANATION OF THE DRAWINGS

FIG. 1 is a partly sectioned view of one embodiment of the separator for a polymer electrolyte type fuel cell according to the invention.

FIGS. 2A, 2B, 2C and 2D are illustrative of one inventive separator fabrication process with reference to the separator of FIG. 1 as an example.

FIGS. 3A, 3B, 3C and 3D are illustrative of another inventive separator fabrication process with reference to the separator of FIG. 1 as an example.

FIG. 4 is illustrative in partial construction of one exemplary polymer electrolyte type fuel cell using the inventive separator.

FIG. 5 is illustrative of a membrane-electrode assembly that forms a part of the polymer electrolyte type fuel cell depicted in FIG. 4.

FIG. 6 is a perspective view of one state where the separator of the polymer electrolyte type fuel cell depicted in FIG. 4 is spaced away from the membrane-electrode assembly.

FIG. 7 is a perspective view of another state where the separator of the polymer electrolyte type fuel cell depicted in FIG. 4 is spaced away from the membrane-electrode assembly, as viewed in a different direction from that of FIG. 6.

### EXPLANATION OF THE PREFERRED EMBODIMENTS

The present invention is now explained with reference to some embodiments shown in the drawings.

[Separator]

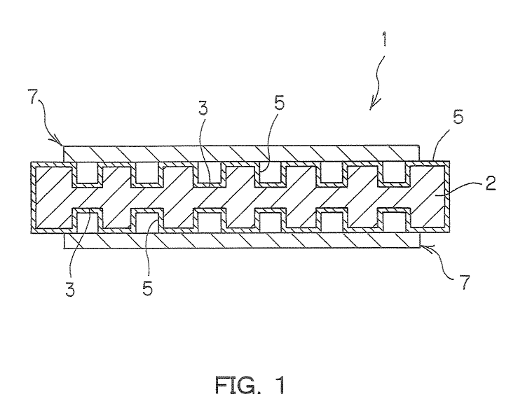

FIG. 1 is a partly sectioned view of one embodiment of the separator for a polymer electrolyte type fuel cell according to the invention. As shown in FIG. 1, a separator 1 of the invention comprises a metal substrate 2, grooves 3 formed in both surfaces of the metal substrate 2, an electro conductive resin layer 5 formed by electro-deposition in such a way as to cover both the surfaces of the metal substrate 2, and gas diffusion layers 7, 7 located on the metal substrate 2 in such a way as to veil the grooves 3.

Preferably, the metal substrate 2 that forms a part of the separator 1 is formed of a material having good electrical conductivity, desired strength, and good processing capability. For instance, stainless, cold-rolled steel sheet, aluminum, titanium and copper are used.

The grooves 3 that the metal substrate 2 has are now explained. A space surrounded with the grooves 3, 3 and the gas diffusion layers 7, 7 then provides a feed groove. When the separator 1 is built in a polymer electrolyte type fuel cell, one of the grooves defines a fuel gas feed groove for feeding fuel gas to one of the adjoining unit cells, and another defines an oxidizing agent gas feed groove for feeding oxidizing agent gas to another of the adjoining unit cells. Alternatively, one of the grooves 3 may provide either of the fuel gas and oxidizing agent gas feed grooves, and another may provide a cooling water groove. Further, one single groove 3 may be formed in only one surface of the metal substrate 2.

No particular limitation is imposed on the configuration of such grooves 3: they may be configured in a continuous zigzag form, comb form, or other form. Likewise, no particular limitation is on depth, width and sectional shape. The metal substrate 2 may also have grooves 3 of different shapes in its front and back surfaces.

The resin layer 5 that forms a part of the separator 1 has electrical conductivity, and is to provide the metal substrate 2 with corrosion resistance. The resin layer 5 may be formed by dispersing an electrically conductive material in a variety of anionic or cationic, synthetic polymer resins capable of electrodeposition to prepare an electrodeposition solution, forming it into a film by means of electrodeposition, and curing the film.

The anionic, synthetic polymer resin here, for instance, includes acrylic resin, polyester resin, maleated oil resin, polybutadiene resin, epoxy resin, polyamide resin, and polyimide resin, which may be used alone or in any desired admixture of two or more. These anionic, synthetic polymer resins may also be used in combination with crosslinkable resins such as melamine resin, phenol resin, and urethane resin. On the other hand, the cationic, synthetic polymer resin, for instance, includes acrylic resin, epoxy resin, urethane resin, polybutadiene resin, polyamide resin, and polyimide resin, which may be used alone or in any desired admixture of two or more. These cationic, synthetic polymer resins may also be used in combination with crosslinkable resins such as polyester resin, and urethane resin.

To impart adhesiveness to the aforesaid synthetic polymer resin having electrodeposition capability, adhesiveness-imparting resins such as rosin resin, terpene resin, and petroleum resin may be added to it, if required.

Such synthetic polymer resins having electro-deposition capability are used for electrodeposition while they are neutralized by alkaline or acidic substances in such a way as to be dissolved or dispersed in water. More exactly, the synthetic polymer resin of anionic nature is neutralized by amines such as trimethylamine, diethylamine, dimethylethanolamine, and diisopropanolamine or inorganic alkalis such as ammonia, and caustic potash. The synthetic polymer resin of cationic nature is neutralized by acids such as formic acid, acetic acid, propionic acid, and lactic acid. The neutralized water-soluble polymer resin is used in the form of a water-dispersion type or water-dissolution type while it is diluted by water.

The resin layer 5 formed by electrodeposition may have a thickness of 1 to 100 μm, preferably 5 to 30 μm. As the thickness of the resin layer 5 is below 1 μm, there is poor corrosion resistance involved, and a thickness exceeding 100 μm is not preferable, because of increased contact resistance or inconsistent shape.

The electrically conductive material contained in the resin layer 5, for instance, includes carbon materials such as carbon particles, carbon nanotubes, carbon nanofibers, and carbon nanohorns, and corrosion-resistant metals. However, the invention is not necessarily limited to such materials: any other material having the desired acid resistance and electrical conductivity may be used. Fine fiber-form carbon materials such as carbon nanotubes, carbon nanofibers, and carbon nanohorns are found to be best suited for imparting electrical conductivity to the resin layer 5. The resin layer 5 may contain such a conductive material in an appropriate amount determined depending on the conductivity demanded for the resin layer 5, for instance, in an amount of 1 to 30% by weight.

It is here noted that the fine fiber-form carbon materials such as carbon nanotubes, carbon nanofibers, and carbon nanohorns are supposed to be a promising material for various applications such as composite materials, and electronic devices, and when they are used as fillers for composite materials, it is possible to impart their physical properties to the composite materials. For instance, carbon nanotubes are improved in terms of electrical conductivity, acid resistance, processing capability, mechanical strength or the like, so that when used as fillers for composite materials, such carbon nanotubes' improved physical properties may be imparted to the composite materials.

The gas diffusion layers (GDL) 7, 7 that form a part of the separator 1 are each formed of a porous collector material; for instance, carbon fibers, alumina or the like may be used. The gas diffusion layers 7, 7 may have a thickness of, for instance, about 20 to 300 μm.

It is noted that the separator 1 here may just as well comprise a seal layer for attaching the unit cells of the polymer electrolyte type fuel cell onto the portion of the metal substrate 2 on the outside of the gas diffusion layers 7, 7.

In the present invention, the resin layer 5 that forms a part of the separator 1 may just as well be formed of a resin layer obtained by adding a conductivity-improving dopant to a resin formed by electrolytic polymerization and composed of an electrically conductive polymer. Electrolytic polymerization is basically a known process wherein currents are passed in an electrolysis solution using an aromatic compound as a monomer with electrodes dipped in it, thereby electrochemically effecting oxidization or reduction for polymerization. The incorporation of the dopant in the resin layer may be carried out by electrical doping wherein the dopant is incorporated in the resin layer at the time of electrolytic polymerization, or liquid-phase doping wherein an electrically conductive polymer is dipped in a dopant liquid or a solution containing dopant molecules after electrolytic polymerization. The dopant here, for instance, includes a donor type dopant such as an alkaline metal, and alkylammonium ions, and an acceptor type dopant such as halogens, Lewis acid, protonic acid, transition metal halides, and organic acids.

The content of the dopant in the resin layer 5 may be properly determined depending on the electrical conductivity that the resin layer 5 must have.

Further in the present invention, the resin layer 5 that forms a part of the separator 1 may have a composite film structure comprising a first resin layer containing a resin formed by electrolytic polymerization of an electrically conductive polymer with a conductivity-improving dopant added to it, and a second resin layer formed by electrodeposition in such a way as to cover the first resin layer and containing an electrically conductive material.

The aforesaid embodiments of the separator according to the invention are given by way of example alone but not by way of limitation.

[Fabrication Process for the Separator]

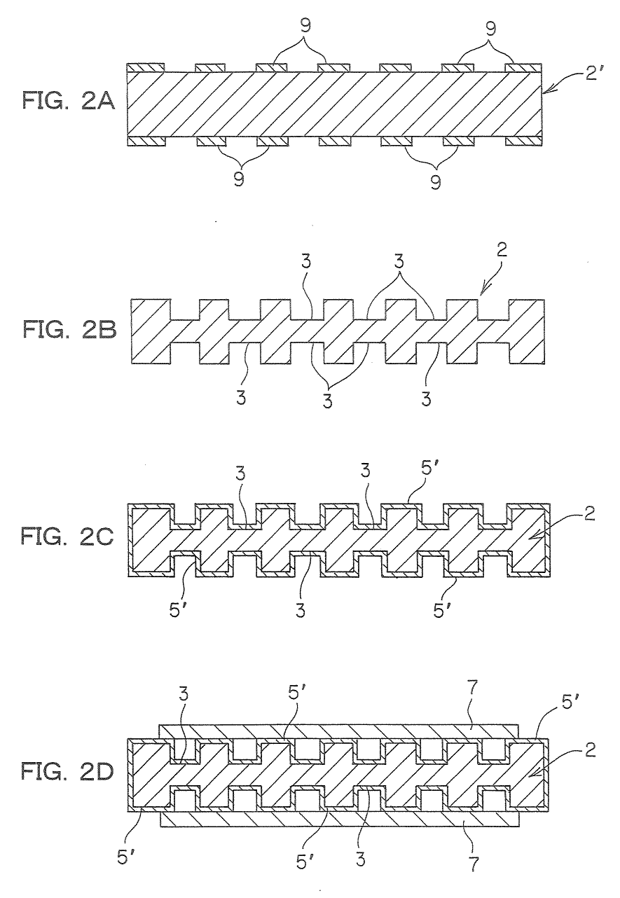

FIGS. 2A, 2B, 2C and 2D are illustrative of one embodiment of how to fabricate the separator of the invention, taking the separator 1 of FIG. 1 as an example.

First, resists 9, 9 are formed on both surfaces of a metal sheet material 2′ in a desired pattern by means of photolithography (FIG. 2A). Using such resists 9, 9 as a mask, the metal sheet material 2′ is then etched from both its surfaces to form the grooves 3, 3, after which the resists 9, 9 are stripped off to obtain the metal substrate 2 (FIG. 2B).

On both surfaces of the metal substrate 2, there are resin coating films 5′ formed by electrodeposition using an electrodeposition solution wherein an electrically conductive material is dispersed in any one of various anionic, or cationic synthetic polymer resins capable of electrodeposition (FIG. 2C). It is herein noted that there may be a first resin layer formed by electrolytic polymerization on each of the metal substrate 2, which resin layer contains a resin comprising an electrically conductive polymer plus an electrical conductivity-improving dopant, and the resin coating film 5′ may then be provided in such a way as to coat the first lens layer using an electrodeposition solution, as described above.

Then, gas diffusion layers 7, 7 are placed on the resin coating film 5′ except the grooves 3, 3 in such a way as to veil the grooves 3, 3 in the metal substrate 2 (FIG. 2D). Thereafter, the resin coating film 5′ is cured into a resin layer 5 so that the inventive separator 1 as shown in FIG. 1 is obtained. The thus formed resin layer 5 has good electrical conductivity plus high corrosion resistance and, at the same time, works joining the gas diffusion layers 7, 7 to the metal substrate 2. A space surrounded with the grooves 3, 3 and the gas diffusion layers 7, 7 then provides a feed groove.

The provision of the aforesaid gas diffusion layers 7, 7, for instance, may be carried out using a transfer sheet having a gas diffusion layer releasably on a substrate. For the substrate here, polyethylene terephthalate film, an alumina foil, a copper foil, a Teflon (registered trade mark) sheet or the like may be used. The formation of the gas diffusion layer on the substrate, for instance, may be implemented by a printing and drying step using a screen printing process relying upon a gas diffusion coating solution wherein carbon fibers, alumina or the like is pasted by methyl acetate, 2-propanol, butanol or the like.

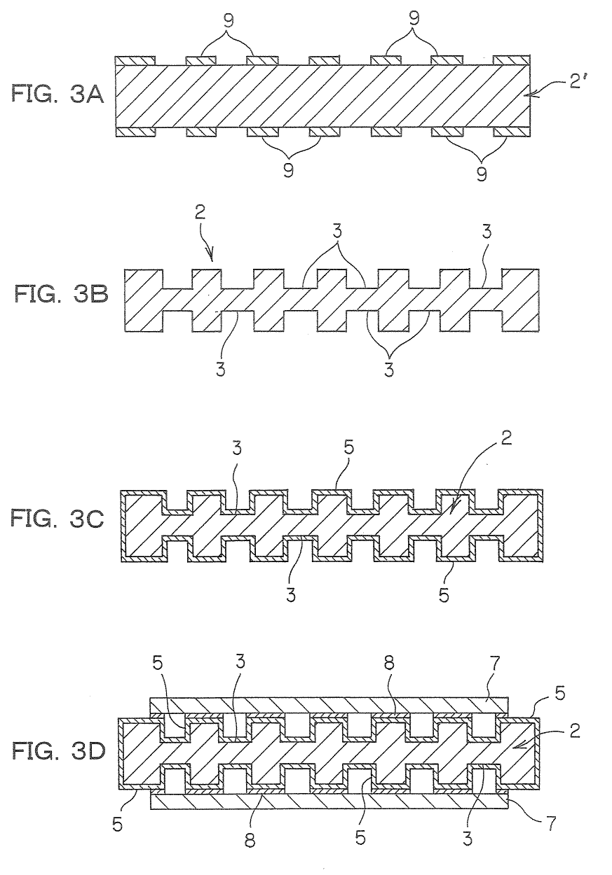

FIGS. 3A, 3B, 3C and 3D are illustrative of another embodiment of how to fabricate the separator of the invention, taking the separator 1 of FIG. 1 as an example.

First, resists 9, 9 are formed on both surfaces of a metal sheet material 2 in a desired pattern by means of photolithography (FIG. 3A). Using such resists 9, 9 as a mask, the metal sheet material 2′ is etched from both its surfaces to form grooves 3, 3, after which the resists 9, 9 are stripped off to obtain the metal substrate 2 (FIG. 3B).

Then, on both surfaces of the metal substrate 2, there are resin coating films formed by electrodeposition using an electrodeposition solution wherein an electrically conductive material is dispersed in any one of various anionic, or cationic synthetic polymer resins capable of electrodeposition, and the films are thereafter cured into the resin layer 5 (FIG. 3C). The thus formed resin layer 5 has good electrical conductivity plus high corrosion resistance.

The aforesaid resin layer 5 may also be formed as follows. The resin layer 5 that includes a resin comprising an electrically conductive polymer with an electrical conductivity-improving dopant contained in it may be formed by electrolytic polymerization. Alternatively, the resin layer 5 may just as well have a composite film structure wherein a first resin layer including a resin comprising an electrically conductive polymer with an electrical conductivity-improving dopant contained in it is formed by electrolytic polymerization on each surface of the metal substrate 2, a resin coating film is then formed in such a way as to coat the first resin layer using an electrodeposition solution as described above, and the resin coating film is thereafter cured into a second resin layer.

Subsequently, gas diffusion layers 7, 7 are joined onto the resin layer 5 except the grooves 3, 3 by way of an electrically conductive layer 8 (FIG. 3D), whereby there is a separator 1 obtained, wherein the feed groove is defined by a space surrounded with the grooves 3, 3 and the gas diffusion layers 7, 7.

The aforesaid conductive adhesive 8, for instance, may be formed using an adhesive containing the aforesaid conductive material. The joining of the gas diffusion layers 7, 7 onto the resin layer 5 may be carried out using such a transfer sheet for the gas diffusion layers as described above.

The aforesaid embodiments of how to fabricate the inventive separator are given by way of example alone but not by way of limitation.

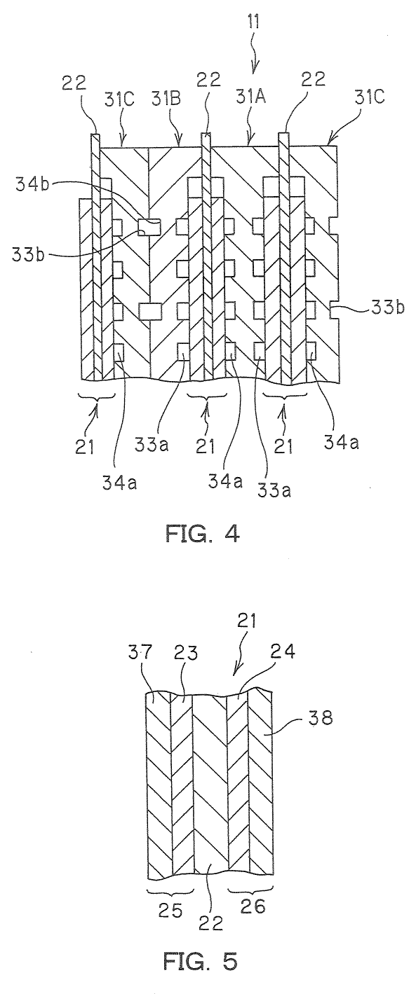

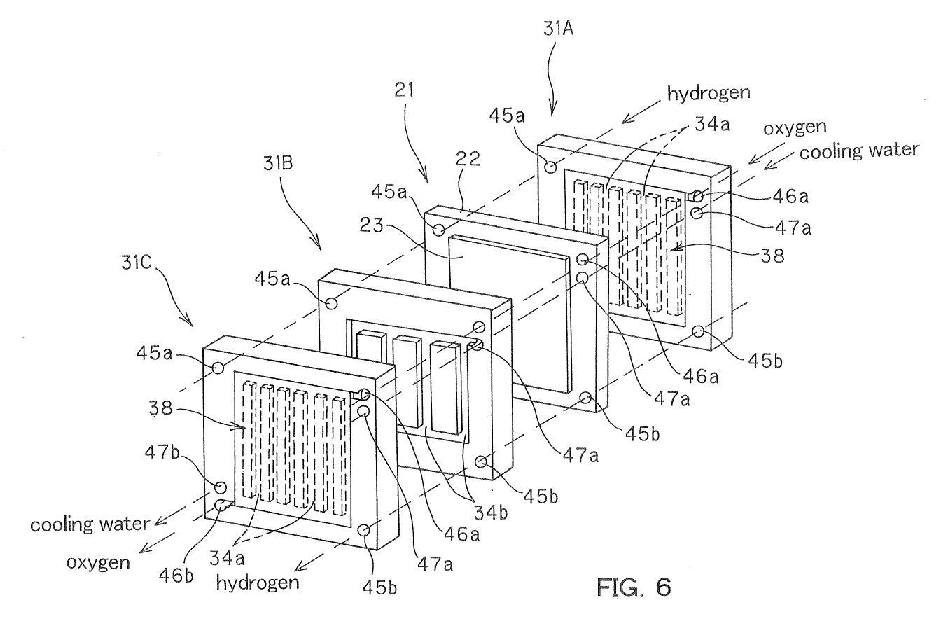

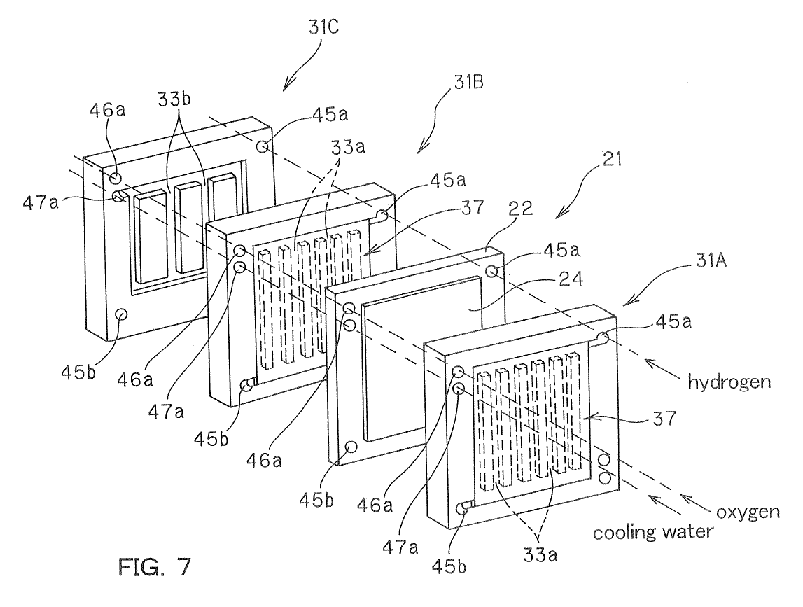

One example of the polymer electrolyte type fuel cell using the separator of the invention is now explained with reference to FIGS. 4, 5, 6 and 7. FIG. 4 is illustrative in fragmental construction of the structure of the polymer electrolyte type fuel cell; FIG. 5 is illustrative of a membrane-electrode assembly that forms a part of the polymer electrolyte type fuel cell; and FIGS. 6 and 7 are perspective views of states where the separator of the polymer electrolyte type fuel cell is spaced away from the membrane-electrode assembly, as viewed from different directions.

In FIGS. 4-7, a polymer electrolyte type fuel cell 11 is built up of a membrane-electrode assembly (MEA) 21 and a separator 31.

As shown in FIG. 5, the MEA 21 has a fuel electrode (hydrogen electrode) 25 comprising a catalyst layer 23 and a gas diffusion layer (GDL) 37 located on one surface of a polymer electrolyte membrane 22 and an air electrode (oxygen electrode) 26 comprising a catalyst layer 24 and a gas diffusion layer (GDL) 38 located on another surface of the polymer electrolyte membrane 22.

The separator 31 is made up of a separator element 31A comprising a fuel gas feed groove 33a in one surface, a gas diffusion layer 37 located in such a way as to veil that groove 33a, an oxidizing agent gas feed groove 34a in another surface and a gas diffusion layer 38 located in such a way as to veil that groove 34a, a separator element 31B comprising a fuel gas feed groove 33a in one surface, a gas diffusion layer 37 located in such a way as to veil that groove 33a and a cooling water groove 34b in another surface, and a separator element 31C comprising a cooling water groove 33b in one surface, an oxidizing agent gas feed groove 34a in another surface and a gas diffusion layer 38 located in such a way as to veil that groove 34a. Such separator elements 31A, 31B and 31C define together the separator of the invention that has on both its surfaces such resin layer 5 as shown in FIG. 1, although not left out in Figs.

At given positions of each separator element 31A, 31B, 31C and the aforesaid polymer electrolytic membrane 22, there are two fuel gas inlet holes 45a, 45b, two oxidizing agent gas inlet holes 46a, 46b, and two cooling water inlet holes 47a, 47b, all in through-hole configuration. And then, the separator elements 31A, 31B, 31C and the catalyst layer 23, polymer electrolyte film 22 and catalyst layer 24 forming the unit cell are stacked together such that the catalyst layer 24 forming a part of the MEA 21 is in engagement with the surface of the separator element 31A on which the gas diffusion layer 38 is located, the catalyst layer 23 forming a part of the MEA 21 is in engagement with the surface of the separator element 31B on which the gas diffusion layer 37 is located, and the surface of the separator element 31B in which the cooling water feed groove 34b is formed is in engagement with the surface of the separator element 31C in which the cooling water feed groove 33b is formed, and this stacking operation is repeated to set up a polymer electrolyte type fuel cell 11. In such a stacked state, the aforesaid two fuel gas inlet holes 45a, 45b define fuel gas feed passages that extend through in the stacking direction; the two oxidizing agent gas inlet holes 46a, 46b define oxidizing agent gas feed passages that extend through in the stacking direction; and the two cooling water inlet holes 47a, 47b define cooling water feed passages that extend through in the staking direction.

The present invention is now explained in more details with reference to more specific examples.

### EXAMPLE 1

A 4.5 mm thick stainless sheet (SUS304) was provided as a metal sheet material, and then decreased on each surface.

Then, a 20 μm thick coating film was formed on each surface of that stainless sheet by screen coating of a photosensitive material (a mixture of casein with ammonium bichromate). The coating film was exposed to light (by a 60-second irradiation with light from a 5 kW mercury lamp) using a photomask for groove formation, and developed (by spraying of a 40° C. warm water) to form a resist.

Then, ferric chloride heated to 70° C. was sprayed onto both surfaces of the stainless sheet through the aforesaid resists to effect half-etching down to a given depth. Then, an aqueous solution of caustic soda at 80° C. was used to strip the resists off, after which the stainless sheet was then rinsed to thereby obtain a metal substrate having a 1-mm wide, 0.5-mm deep groove of almost semi-circular shape in section that meandered a length of 1,250 mm at an amplitude of 50 mm and a pitch of 2 mm.

Apart from this, a gas diffusion coating solution having the following composition was printed and dried on a 25 μm thick polyethylene terephthalate film (Naphlon made by Nittoh Denko Co., Ltd.) by a screen printing technique into a 50 μm thick releasable gas diffusion layer, thereby obtaining a gas diffusion layer transfer sheet.

(Composition of the Gas Diffusion Coating Solution)

| | |
|---|---|
| Carbon long fibers (Torayca Milled Fiber made | 20% by weight |
| by Toray Co., Ltd.) | |
| Carbon short fibers (Torayca Cut Fiber made | 35% by weight |
| by Toray Co., Ltd.) | |
| 2-Propanol | 45% by weight |

On the other hand, an epoxy electrodeposition solution was prepared as follows.

First, while 1,000 parts by weight of diglycidyl ether of bisphenol A (having an epoxy equivalent of 910) were kept at 70° C. under agitation, 463 parts by weight of ethylene glycol monoethyl ether were dissolved in it with a further addition of 80.3 parts by weight of diethylamine for a 2-hour reaction at 100° C., thereby preparing an amine-epoxy adduct (A).

Apart from this, 0.05 part by weight of dibutyltin laurate was added to 875 parts by weight of Colonate L (Nippon Polyurethane Co., Ltd., diisocyanate: 75% by weight nonvolatile matter of 13% NCO), which were then heated to 50° C. for the addition of 390 parts by weight of 2-ethyl-hexanol, whereupon they were allowed to react at 120° C. for 90 minutes. The obtained reaction product was diluted with 130 parts by weight of ethylene glycol monoethyl ether to obtain a component (B).

Then, a mixture of 1,000 parts by weight of the aforesaid amine-epoxy adduct (A) and 400 parts by weight of the component (B) was neutralized with 30 parts by weight of glacial acetic acid, and thereafter diluted with 570 parts by weight of deionized water to prepare a resin A with 50% by weight of nonvolatile matter. An epoxy electrodeposition solution was prepared by blending together 200.2 parts by weight of the resin A (with the content of the resinous component being 86.3 by volume), 583.3 parts by weight of deionized water and 2.4 parts by weight of dibutyltin laurate.

Then, added to, and dispersed in, the aforesaid epoxy electrodeposition solution were an electrically conductive material, i.e., carbon nanotubes (Carbere made by GSI Creos Co., Ltd.) in an amount of 20% by weight with respect to the resin solid matter to obtain an electro-deposition solution.

While the aforesaid electrodeposition solution was held at 20° C. under agitation, the aforesaid metal substrate was dipped in that solution for a 30-second electrodeposition at an inter-electrode distance of 40 mm and a voltage of 50 V. The metal substrate was then pulled up.

Then, the gas diffusion layer of the gas diffusion transfer sheet prepared as described above was contact bonded to the aforesaid resin coating film, and the whole was heated and cured at 180° C. for 1 hour in a nitrogen atmosphere, after which the polyethylene terephthalate film was peeled off, whereby there was the separator of the invention obtained, wherein a 15 μm thick electro-deposition layer (resin layer) was formed on the metal substrate inclusive of the grooves and, at the same time, the gas diffusion layer was joined to the metal substrate through the resin layer in such a way as to veil the grooves.

### EXAMPLE 2

As in Example 1, a metal substrate having grooves was prepared.

As in Example 1, a gas diffusion layer transfer sheet was prepared.

An epoxy electrodeposition solution was prepared, too, as in Example 1. Using that electrodeposition solution, electrodeposition and rinsing were carried out under the same conditions as in Example 1 to form a resin coating film. Further, the heating and curing step was performed at 180° C. for 1 hour in a nitrogen atmosphere to form a 15 μm thick electrodeposition layer (resin layer) on the metal substrate inclusive of the grooves.

Then, a gold paste (made by Three Bond Co., Ltd.) was coated onto the gas diffusion layer of the aforesaid gas diffusion layer transfer sheet (in a coating amount of 3 g/m²) by means of a screen printing technique to form an electrically conductive adhesive layer.

Then, the gas diffusion layer of the gas diffusion transfer sheet was contact bonded to the resin layer by way of the aforesaid conductive adhesive layer, and the whole was heated and cured at 200° C. for 1.5 hours, after which the polyethylene terephthalate film was peeled off, whereby there was the separator of the invention obtained, wherein the gas diffusion layer was joined to the metal substrate by way of the resin layer in such a way as to veil the grooves.

What is claimed is:

1. A separator for a polymer electrolyte type fuel cell, characterized by comprising a metal substrate having a groove formed in at least one surface, an electrically conductive resin layer formed by electro-deposition in such a way as to cover said metal substrate, and a gas diffusion layer located on the surface of said metal substrate having a groove in such a way as to veil the groove.

2. The separator for a polymer electrolyte type fuel cell according to claim 1, wherein said resin layer contains an electrically conductive material.

3. The separator for a polymer electrolyte type fuel cell according to claim 2, wherein said electrically conductive material is at least one of a carbon particle, a carbon nanotube, a carbon nanofiber, a carbon nanohorn, and a corrosion-resistant metal.

4. The separator for a polymer electrolyte type fuel cell according to claim 1, wherein said resin layer has a thickness ranging from 0.1 to 100 μm.

5. A separator for a polymer electrolyte type fuel cell, characterized by comprising a metal substrate having a groove formed in at least one surface, an electrically conductive resin layer formed by electrolytic polymerization in such a way as to cover said metal substrate, and a gas diffusion layer located on the surface of said metal substrate having a groove in such a way as to veil the groove, wherein said resin layer includes a resin comprising an electrically conductive polymer and further containing a conductivity-improving dopant.

6. The separator for a polymer electrolyte type fuel cell according to claim 5, wherein said resin layer has a thickness ranging from 0.1 to 100 μm.

7. A separator for a polymer electrolyte type fuel cell, characterized by comprising a metal substrate having a groove formed in at least one surface, an electrically conductive resin layer formed by electrolytic polymerization in such a way as to cover said metal substrate, and a gas diffusion layer located on the surface of said metal substrate having a groove in such a way as to veil the groove, wherein said resin layer comprises a first resin layer wherein a conductivity-improving dopant is contained in a resin comprising an electrically conductive polymer formed by electrolytic polymerization, and a second resin layer formed by electrodeposition in such a way as to cover said first resin layer and containing an electrically conductive material.

8. The separator for a polymer electrolyte type fuel cell according to claim 7, wherein said electrically conductive material is at least one of a carbon particle, a carbon nanotube, a carbon nanofiber, a carbon nanohorn, and a corrosion-resistant metal.

9. The separator for a polymer electrolyte type fuel cell according to claim 7, wherein said resin layer has a thickness ranging from 0.1 to 100 μm.

10. A process for fabrication of a separator for a polymer electrolyte type fuel cell built up of a plurality of unit cells stacked one upon another, each with electrodes located on both sides of a solid polymer electrolyte membrane, characterized by comprising steps of:
forming a groove in at least one surface of a metal sheet material to make a metal substrate,
forming an electrically conductive resin coating film in such a way as to cover said metal substrate, using an electrodeposition solution, and
engaging and placing a gas diffusion layer on said resin coating film except said groove in such a way as to veil said groove in said metal substrate, and thereafter curing said resin coating film to form an electrically conductive resin layer while joining said gas diffusion layer to said metal substrate to form a feed groove surrounded with said groove and said gas diffusion layer.

11. A process for fabrication of a separator for a polymer electrolyte type fuel cell built up of a plurality of unit cells stacked one upon another, each with electrodes located on both sides of a solid polymer electrolyte membrane, characterized by comprising steps of:
forming a groove in at least one surface of a metal sheet material to make a metal substrate,
forming a resin coating film in such a way as to coat said metal substrate, using an electrodeposition solution, and thereafter curing said resin coating film to form an electrically conductive resin layer, and
joining a gas diffusion layer to a site of said resin layer except said groove via an electrically conductive adhesive in such as a way as to veil said groove in said metal substrate, thereby forming a feed groove surrounded with said groove and said gas diffusion layer.

12. A process for fabrication of a separator for a polymer electrolyte type fuel cell built up of a plurality of unit cells stacked one upon another, each with electrodes located on both sides of a solid polymer electrolyte membrane, characterized by comprising steps of:
forming a groove in at least one surface of a metal sheet material to make a metal substrate,
using electrolytic polymerization to form a resin layer including a resin comprising an electrically conductive polymer and containing an electrical conductivity-improving dopant in such a way as to cover said metal substrate, and
joining a gas diffusion layer to a site of said resin layer except said groove via an electrically conductive adhesive in such as a way as to veil said groove in said metal substrate, thereby forming a feed groove surrounded with said groove and said gas diffusion layer.

13. A process for fabrication of a separator for a polymer electrolyte type fuel cell built up of a plurality of unit cells stacked one upon another, each with electrodes located on both sides of a solid polymer electrolyte membrane, characterized by comprising steps of:
forming a groove in at least one surface of a metal sheet material to make a metal substrate,
using electrolytic polymerization to form a first resin layer including a resin comprising an electrically conductive polymer and containing an electrical conductivity-improving dopant in such a way as to cover said metal substrate and then using an electrodeposition solution to form an electrically conductive resin coating film in such a way as to cover said first resin layer, and
engaging and placing a gas diffusion layer on said resin coating film except said groove in such a way as to veil said groove in said metal substrate, and thereafter curing said resin coating film to form an electrically conductive resin layer while joining said gas diffusion layer to said metal substrate to form a feed groove surrounded with said groove and said gas diffusion layer.

14. A process for fabrication of a separator for a polymer electrolyte type fuel cell built up of a plurality of unit cells stacked one upon another, each with electrodes located on both sides of a solid polymer electrolyte membrane, characterized by comprising steps of:
forming a groove in at least one surface of a metal sheet material to make a metal substrate,
using electrolytic polymerization to form a first resin layer including a resin comprising an electrically conductive polymer and containing an electrical conductivity-improving dopant in such a way as to coat said metal substrate, then using an electrodeposition solution to form a resin coating film in such a way as to coat said first resin layer, and thereafter curing said resin coating film to form a second, electrically conductive resin layer, and
joining a gas diffusion layer to a site of said second resin layer except said groove via an electrically conductive adhesive in such as a way as to veil said groove in said metal substrate, thereby forming a feed groove surrounded with said groove and said gas diffusion layer.
